(19) United States
(12) Patent Application Publication
(10) Pub. No.: US 2011/0141285 A1
(43) Pub. Date: Jun. 16, 2011

(54) HD-Xanna

(76) Inventors: Mikhail Tsinberg, New York, NY (US); Leon Tsinberg, Bronx, NY (US)

(21) Appl. No.: 12/653,567

(22) Filed: Dec. 16, 2009

(51) Int. Cl. H04N 5/33

(52) U.S. Cl. 348/164; 348/E05.09

(57) ABSTRACT

Normally infrared data transmitted to TV is used for command protocols. The HD-XANNA converts any audio and video signal through a processor into ATSC or NTSC or SECAM and then converts this signal again into an Infrared Digital Television channel (IRDTV). This IRDTV signal travels wirelessly to an infrared adapter either on a computer or TV. The signal is then converted into standard ATSC or NTSC or SECAM which travels via a coaxial cable into the ATSC input on a given television. Although ATSC is used in the RF spectrum today, IRDTV enables a localized transmission in a secure environment giving it complete privacy settings not available through RF. The Antenna input's current off air broadcast use can now be used for receiving IRDTV signals. By feeding multiple IRDTV signal(s) from transmitter units into receiver unit(s), the TV channels switch among sources by changing channels.

### BACKGROUND

1. Field of the Invention

The present invention relates to Audio and Video transmission and switching for use with a television receiver

2. Description of the Prior Art

In prior art, private infrared channels have been used for remote control systems for use in a Television (TV) environment such that the user may send commands to a Television System to control volume, channels, contrast, brightness, and other TV command functions.

With the advent of Digital Television Broadcast, U.S. Pat. No. 6,996,133, High Definition Video comprising 6 channel audio is now the public broadcast standard in the United States pursuant to 47 U.S.C. §303(s) authorizing the commissioner of the Federal Communications Commission to regulate public broadcast frequencies in the United States.

Subsequently, 16 F.C.C.R. §5946 confirmed that as of April, 2009 all Televisions sold in the United States must accept DTV channels. At the completion of the Rulemaking process adopted by the FCC, the Consumer Electronics Association argued, inter-alia, that 85% of Americans do not use off-air Television broadcast and that the FCC was placing an unfair burden on consumers and manufactures to implement the Digital Television (DTV), ATSC standard. In Consumer Electronics Association v. Federal Communications Commission 347 F.3d 291, the United States Court of Appeals, District of Columbia Circuit affirmed the FCC regulation but for the fact that the TV tuner channel was underutilized by most Americans.

With such prior art, the infrared channel has never been utilized to transmit High Definition Television (HDTV) data whereby a signal can carry video for television at 1440×1080i (1440 horizontal lines by 1080 vertical lines, interlaced) and Audio up to 6 channels (commonly known as 5.1 or 5 surrounding speakers by 1 bass channel speaker) within the limited data transmission provided for in InfraRed (IR).

Infra Red is a spectrum that by its characteristics through light, carries 4 times less information than Radio Frequency (RF), and is limited to line of site broadcasting only. Line of sight means that the source device must either face the light stream in order to accept the data that is being transferred through it or face a reflection of the light stream as is the case with reflective glass or IR receiver and repeater units. The line of sight qualities of this invention allow the first truly private broadcasting instrument.

Recent developments by Microsoft's Windows 7, enable computer image displacement upon a Television, but cannot guarantee these images to be truly private unless plugged in through a wire. The wireless technology utilized therein bases transmission on Radio Frequency (RF). Systems like Linksys (Wireless interne networking) can be used to transmit display data by utilizing “private” networking software systems. These systems are always at risk to infiltration because they use Radio Frequency which has inherent characteristics of public travel. In other words, RF can travel through walls and windows.

Radio Frequency broadcast may be intercepted by superseding software control systems by techniques known to a person having extraordinary skill in the art of software engineering. This is commonly referred to as wireless network hacking.

By transmitting display data through Infrared, a user can limit the range of her display data to an area where infrared light cannot physically pass. Therefore a network surrounded by walls or reflective glass can enjoy the comfort of secured point to point Audio/Video display and having the burden of plugging in unnecessary cables.

Infrared remote control enjoys such private bit-stream data properties, but is limited to simple command functionality. More complicated remote control systems which control many devices such as lighting and security still have only utilized a small part of Infrared's data carrying capability. By combining the teaching of DTV public transmission, and infrared remote controls, a new channel is hereby created where the audio and video qualities of High Definition Television broadcast can be maintained, with the added feature of complete privacy from public interception.

### OBJECTS AND SUMMARY OF THE INVENTION

Accordingly, it is an object of the present invention to provide HDTV channels from a multitude of sources through a transmitter which transcodes data into ATSC, Modulates said data into an IR capable frequency, and than transmits this frequency through an IR hi speed emitter.

Once this channel has been created, Infrared ATSC shall travel over a distance depending on the strength of the emitter, into an IR receiver found on all Television devices.

When this new channel is received by an IR receiver, it than re-modulates back to ATSC and connects with any television antenna coaxial input and displays whatever content was broadcasted at 1080i video and 6 channel audio on the television that was intended by the user to receive this signal.

Because IR is a light based bandwidth, it cannot travel through walls and is reflected by glass. Unlike present ATSC signals, which use a Radio Frequency bandwidth which is intended to travel through walls, buildings, concrete, and the like for mass distribution over the air in urban environments; this channel carries the same data over a limited distribution area to stay private within one's home.

The preferred embodiment of this invention involves an external transmitter and external receiver unit, but may be designed in a more compact fashion to work inside a unit with display capabilities to act as an integrated Transmitter or Receiver unit depending on its intended use.

It is a further feature that multiple channels can be transmitted and selectively selected, such that a plurality of analog or digital, Audio and Video (AV) sources can transmit data over several modulated Infra-Red Digital Television (IRDTV) channels, and the Receiver can be set to recognize any given channel and display that channel over an Advanced Television Systems Committee (ATSC) standard input source of the TV.

### BRIEF DESCRIPTION OF THE DRAWINGS

FIG. 1 Shows how a multitude of AV sources can input into the components of the IRDTV transmitter and may be used to broadcast publicly or privately. Public broadcast is public domain prior art RF-DTV, ATSC (FIG. 1 reference numeral 400), and Private Broadcast is novel in how it is claimed within (FIG. 1 reference 300).

FIG. 2 explains how computer data converts to DTV as ATSC

FIG. 3 explains how ATSC can be modulated to IR

FIG. 4 explains how IR is broadcasted at standard modulation frequencies by showing the intended use of IRATSC and how it is received by an IR input on the TV channel and how it moves into an RF antenna located on every Television

FIG. 5 shows how the IR signal is re-modulated back from IRDTV into RFATSC for coaxial transmission into a Televisions RF antenna input

FIG. 6 shows the process that the IRATSC data must undergo to convert into a standard ATSC channel and shows how a cable travels from the IR input of a Television into a receiver device that converts the signal into RF coaxial and plugs into the TV ATSC/RF input.

### DESCRIPTION OF THE PREFERRED EMBODIMENT

Now an embodiment of the preferred designs will be described with reference to the attached drawings.

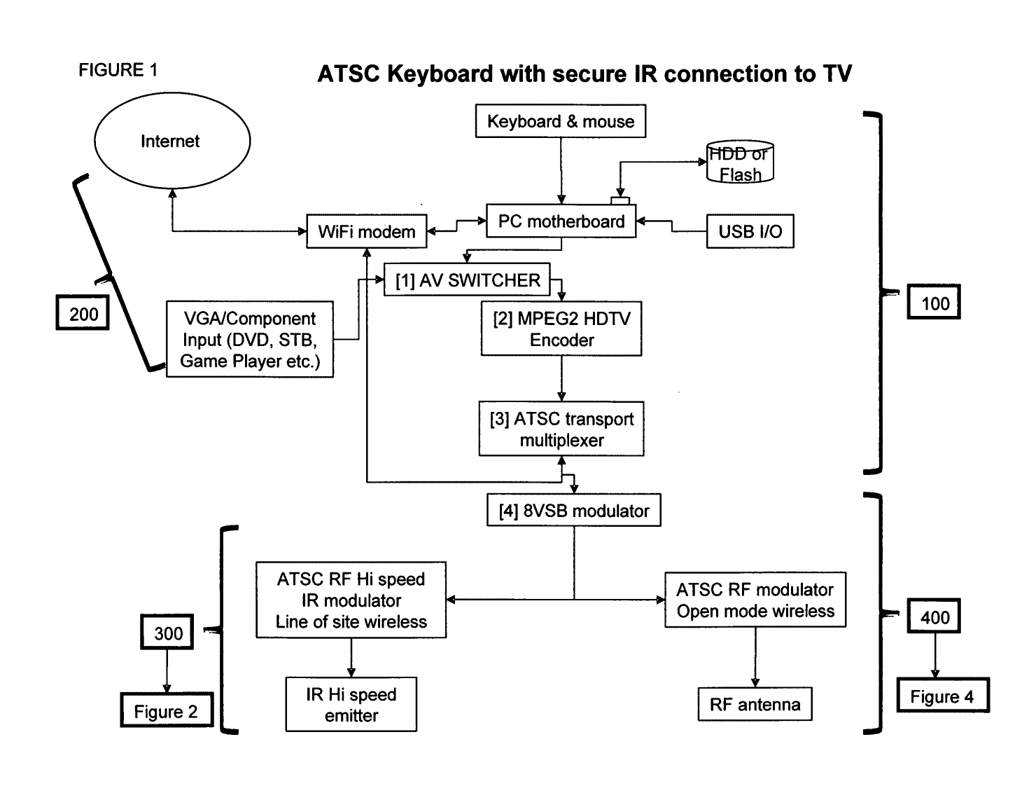

FIG. 1 shows an example of how a computer, USB, VGA, Component, composite, s-video, HDMI, and DVI signals are received and processed through a transmitter which enables RF-ATSC or IR-ATSC broadcast. FIG. 1 reference numeral 100 designates a computer process which transmits data into input 1 of the transmitter. FIG. 1 reference numeral 200 designates transmission from a DVD, STB, BRD, Game player, or any other AV source which utilizes VGA, Component, composite, s-video, HDMI, and DVI components to be plugged into other input channels of the broadcaster unit.

FIG. 1 reference numeral 300 shows the prior art RF-DTV-ATSC broadcast process that such inputs undergo to transmit such information publicly through disruptive mediums such as walls and glass.

FIG. 1 reference numeral 400 shows the process that the various inputs undergo for private IR-ATSC broadcast which is not intended for public broadcast and cannot travel through disruptive mediums such as walls and glass

FIG. 1 reference numeral 1 is an AV switcher which accepts 8 different AV sources including; USB, YPrPb, CV, S-video, HDMI, CATS, DVID, DVIA, and splits any one of these sources into FIG. 1 numeral 2. USB is a computer data input device. YPrPb is a standard analog signal which takes AV data and transmits it through three coaxial cables which are dedicated to red, blue, and a green, horizontal, vertical bit-stream standard. CV is composite video which combines red, green, blue, horizontal and vertical into one analog coaxial cable. HDMI is an Audio and Video standard which carries AV data at 2.4 giga hertz per second for transmission of 1080P, 8 channel audio over separate copper lines. DVID is HDMI without the audio. DVIA is DVID encoded over analog.

FIG. 1 reference numeral 2 is an MPEG2 HDTV encoder which converts any one source into HDTV data. This conversion takes place by a process found in U.S. Pat. No. 6,369,857. HDTV data is defined as digital or analog bit-streams which output TV data at 480P, 720P, 1080i, 768p, or 1080p. “I” refers to interlaced which is ½ a frame of a still picture. P is defined as progressive which is a full picture frame of data. The number before the i and the P refers to the amount of vertical lines said image uses to publish on a monitor.

FIG. 1 reference numeral 3 is an ATSC transport multiplexer which takes HDTV data and transmits said data into ATSC. ATSC data then travels through FIG. 1 reference numeral 4. ATSC is the standard for broadcasting Radio-Frequency, digital television in the United States, at 1080i HDTV through the air for public channel access. This standard was developed by Zenith described in U.S. Pat. No. 4,694,338.

FIG. 1 reference numeral 4 is an 8VSB modulator which Encodes a single ATSC signal to specific code such that the Television tuner may recognize what channel the signal is being broadcasted to. After modulation, the signal then travels either through the process delineated as 300 or the process delineated as 400.

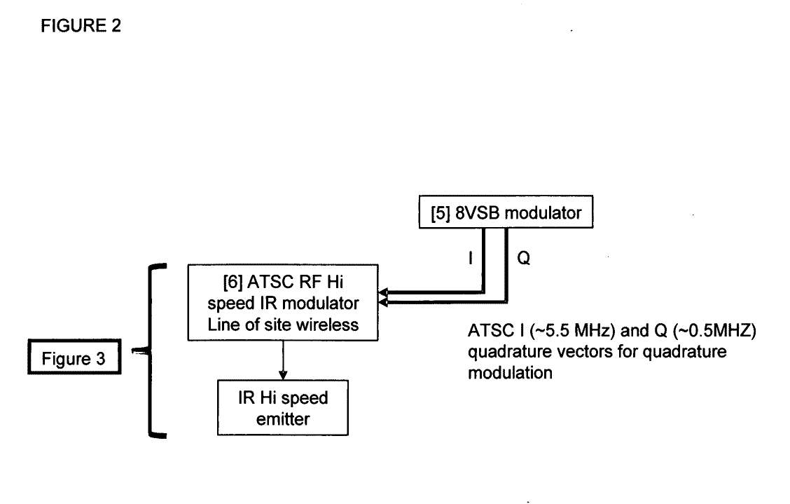

FIG. 2 describes the 8VSB modulation mentioned in the preferred embodiment supra at FIG. 1 reference numeral 300. This modulator takes an ATSC signal and multiplies the bit-stream of that data by 0.05 megahertz in a process call quadrature modulation. Quadrature modulation takes ATSC and encodes it to keep the same characteristics of ATSC but slightly alters the bit-rate so that the data has a slight variable in which the ATSC input on the Television can recognize what channel the intended data is to be retransmitted at. This modulation is accomplished by splitting HDTV data into two channels referenced as the I channel and Q channel. This modulation standard was developed by Zenith, described in U.S. Pat. No. 4,694,338.

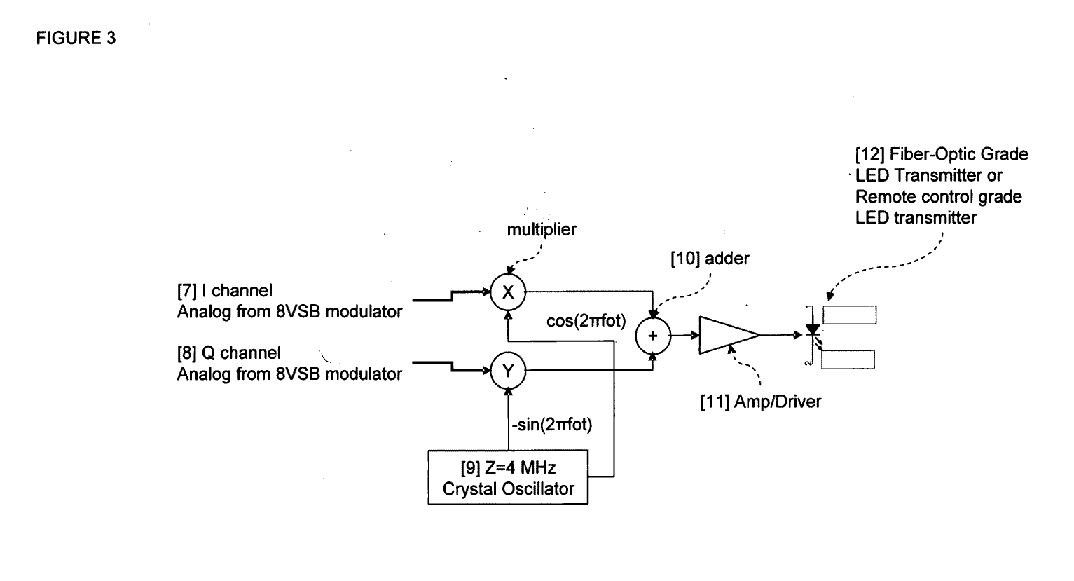

FIG. 2 reference numeral 6 is an ATSC RF Hi Speed IR modulator with Line of Site Wireless. This is a high grade IR transmitter which pulsates Infra Red light at a coded frequency similar to Remote Control command data but much faster such that more information can be transmitted than conventionally used for mere command processes. This process is described in FIG. 3 infra.

FIG. 3 combines 3 data variables that encode data such that an Infra-Red Light Emitting Diode (IR LED) can transmit Infra-Red Digital Television (IRDTV) in order to achieve the desired private home viewing effect.

The first data variable is the I channel which is a 5.5 mega hertz per second bit-stream which is labeled as variable X in FIG. 3 reference numeral 7.

The Second data variable is the Q channel which is a 0.05 mega hertz per second bit-stream which is labeled as variable Y in FIG. 3 reference numeral 8.

The Third data variable is a 4 mega hertz Crystal Oscillator which creates a carrier frequency (fo) that introduces an artificially created bit-stream at this stage of signal transmutation. This signal allows for a third variable in order to undergo a multiplication process from which an Infra-Red Digital Television (IRDTV) channel can be created referenced as FIG. 3 numeral 9, cross reference as variable Z.

FIG. 3 works through a three variable multiplication function, which applies to a two step addition function: The multiplication function is labeled FIG. 3 numeral 500, the addition function is labeled FIG. 3 numeral 600, and the IR transmission process if labeled FIG. 3 numeral 700.

FIG. 3 reference numeral 500 introduces a carrier frequency (fo) of a 4 mega hurtz signal if astandard IR LED or up to 1 Giga Hurtz if a Fiber Optic LED as described in FIG. 3 reference numeral 6. By multiplying the function described in FIG. 3 reference numeral 6 by negative sin times two times π times fot times variable Y which is FIG. 3 reference number 8, the first two multiplied variables create a signal which travels to FIG. 3 reference 9. A second multiplication sequence also travels to FIG. 3 reference numeral 9 by multiplying FIG. 3 reference numeral 6 times cos times two times π times fot times variable X which is FIG. 3 reference numeral 7

FIG. 3 reference 10 is an adder that takes the two described multipliers and adds them together in order to produce an appropriate modulated signal which travels to a driver amplifier which is FIG. 3 reference 11.

FIG. 3 reference 11 than amplifies this newly created signal through a driver creating an electronic code which is sent to FIG. 3 reference numeral 12.

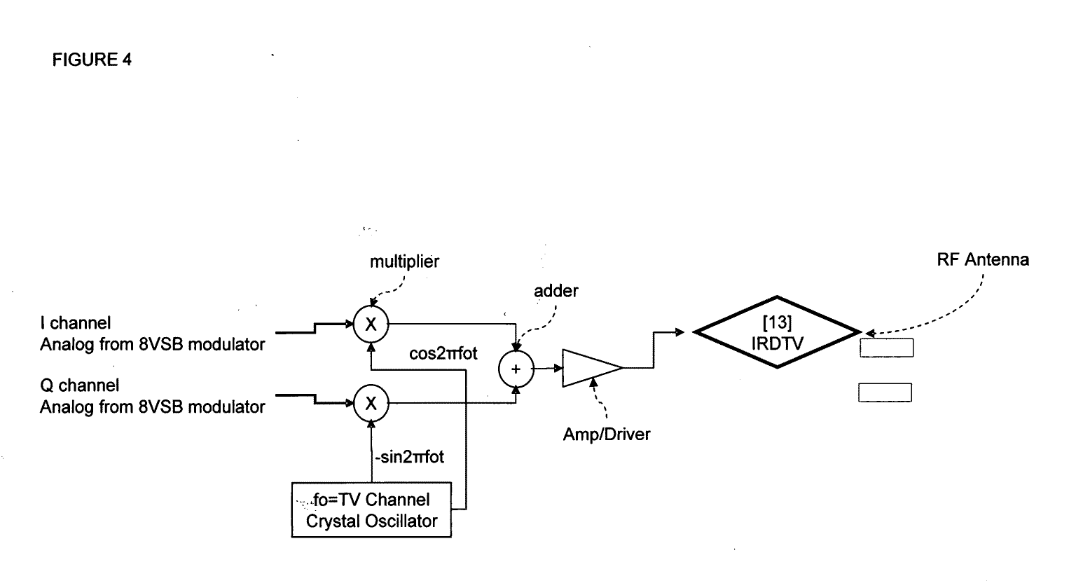

FIG. 3 reference numeral 12 accepts the amplified, coded signal and transmits this signal into an IR LED which pulsates an otherwise constant infrared light signal within a sequence which creates IRDTV channels described in FIG. 4, reference numeral 13

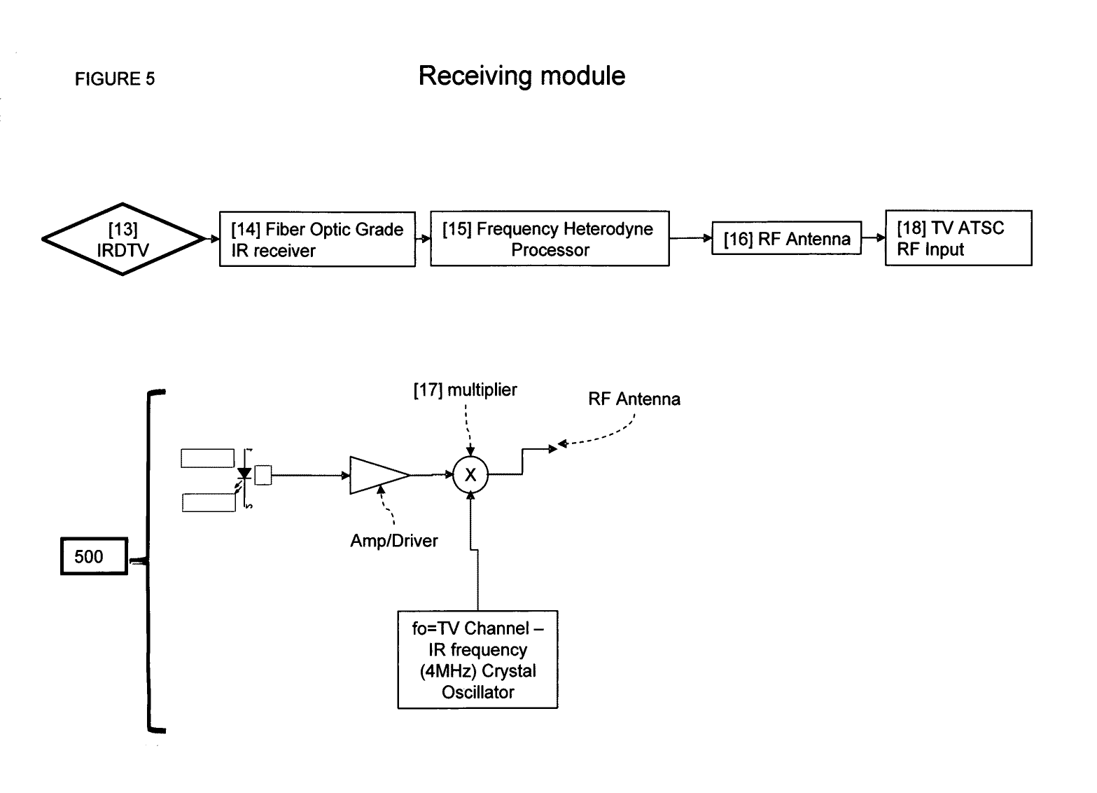

FIG. 4 shows the interplay of FIG. 3 and the subsequent IRDTV channel which ultimately winds up to the TV's RF Coaxial input though the receiving module described infra by FIG. 5. IRDTV is infrared light, sequenced such that a receiving unit can decode the infrared bit-stream into ATSC in order to broadcast the original content on any Antenna input of a Television.

FIG. 5 is the receiving unit which accepts IRDTV, converts IRDTV to RFATSC, and Broadcasts the original content via Coaxial cable. The re-created RFATSC travels into a Television's RF coaxial input slot. This is accomplished first by capturing IRDTV by a fiber optic grade IR receiver labeled FIG. 5 reference numeral 14 and distributing that signal via coaxial cable to a Frequency Heterodyne Processor labeled FIG. 5 reference numeral 15.

FIG. 5 reference numeral 13 is a frequency heterodyne processor which takes the IRDTV signal and splits the signal into a Q channel and an I channel already described. By applying the properties of oscillating frequencies described in the mathematical sin function, the heterodyne processor inverts the single IR signal into a two channel oscillating frequency. Once these two channels are reverted back to oscillation, they travel through a coaxial cable into an RF antenna which is FIG. 5 reference numeral 16, through a process described as FIG. 5 reference numeral 500.

FIG. 5 reference numeral 500 describes the inverse mathematical function described in FIG. 3. A single pulsating light signal creates a data bit stream ranking from 30 kila hertz to 100 kila hertz. That signal is first amplified because of natural signal degradation as light travels further thereby wearing away its focus. After LED transmission IR is focused, whereas the further distance it travels the less focused and precise IR becomes. Therefore amplification refocuses the original IR data and is achieved by a driver shown in FIG. 5 numeral 15.

After the signal is amplified it travels via CATS cable to a multiplier which is FIG. 5 reference numeral 17. This amplified signal is described as fo. The formula being applied to achieve reverse modulation is fo equals TV channel minus 4 Mega hertz. The TV channel is the I channel at 0.5 mega hertz which is an encoded signal which decodes the Q-channel based on the signal the Television was directed to look for by the tuner. 4 mega hertz is added to the Q channel by a Crystal Oscillator. Because Radio Frequency carries 4 wavelengths in the ATSC context, the crystal is shaped to multiply the infrared light frequency by a factor of 4. Once the multiplier applies the reverse formula described in FIG. 3, the original ATSC signal is restored. The signal is displayed on the Television at virtually the same time the Transmitter produced it, minus a small time delay based on the distance light traveled from the IRLED transmitter to the RF antenna input which is FIG. 5 reference numeral 18. This process culminates at the TV's RFATSC antenna input which is FIG. 5 reference numeral 18.

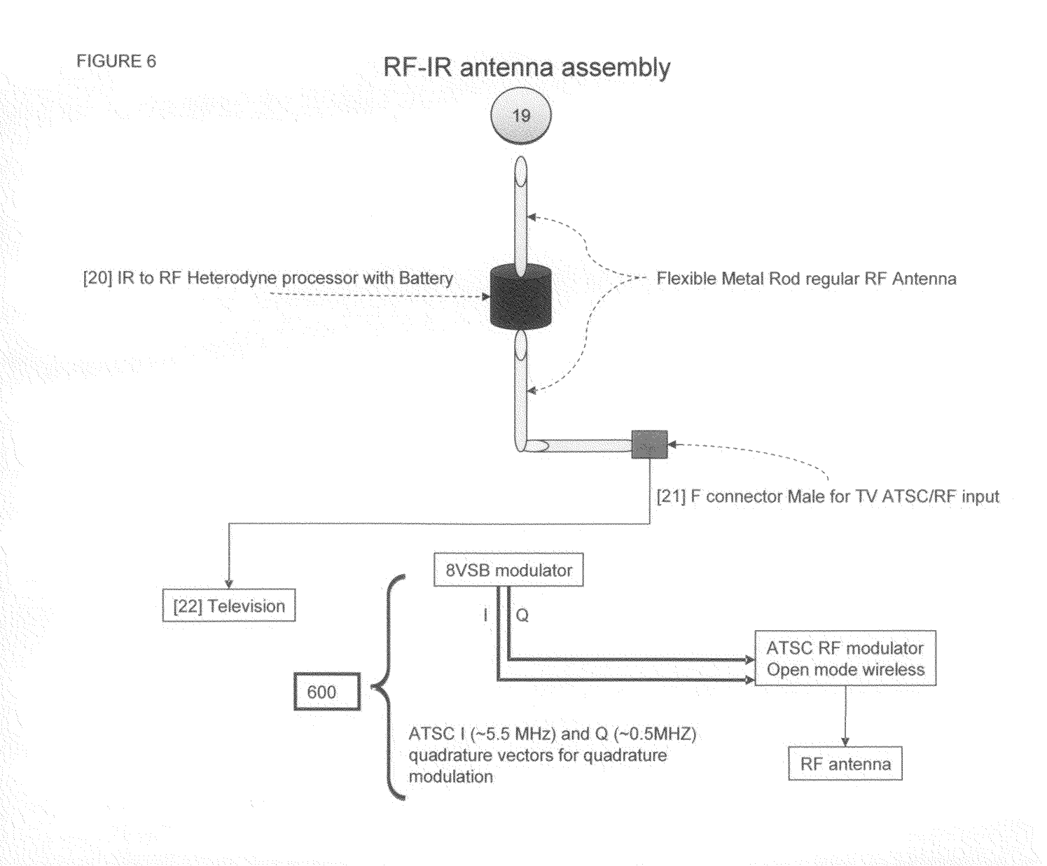

FIG. 6 describes the preferred embodiment of the Receiver unit. FIG. 6 reference numeral 17 is a standard IR window located in front of all Television units. Although the IR window is directed to the Televisions IR receiver, the IRDTV signal is intercepted by an IR repeater described in FIG. 6 reference numeral 18. The intercepted IR signal travels down the first flexible metal rod which is FIG. 6 reference numeral 19. This Flexible medal rod is a cable capable of transmitting regular RFDTV information. This rod connects to FIG. 6 reference numeral 20.

FIG. 6 is an embodiment of FIG. 5. Once the signal is decoded by FIG. 6 reference numeral 20 it travels to FIG. 6 reference numeral 21.

FIG. 6 reference numeral 21 is the same metal rod described in FIG. 6 reference numeral 19, with angular flexing capabilities. It can be shaped behind any mounted or un-mounted Television to connect to FIG. 6 reference numeral 22.

FIG. 6 reference numeral 21 is an F connector Male end of a cable to be plugged into FIG. 6 reference numeral 22.

FIG. 6 reference numeral 23 is the Televisions RFATSC input slot which connects to the TV tuner. The TV tuner can discreetly accept any one of the 8 original sources originally broadcasted by the transmitter unit, so long as the user directs the tuner to tune to a certain channel. As a result, the home viewer can change channels on his Television and watch any of the original sources by simply changing channels. For example, if the computer was set to channel 3, the DVD to channel 4, and the game consul to channel 5. The user can set the TV tuner to channel 3 to watch his computer content, channel 4 to watch DVD content, and channel 5 to play his game consul content.

1. An IRDTV infrared channel for the purpose of secure, wireless transmission of high-definition television content comprising:

2. The objects of claim 1 embodied as an external transmitter spaced between an external receiver consisting off:

3. The objects of claim 2 wherein the external transmitter unit accepts any analog or digital input, encodes said inputs into high definition through an MPEG 2 encoder,
re-encodes said signal into ATSC, splits ATSC into multiple channels through an 8 VSB modulator, adds a 4 Mhz signal which oscillates said channel modulation,
multiplies the three signal variables, adds the remaining two signal variables,
amplifies the remaining signal, and drives said signal code to a hi frequency IR LED which pulsates according to said code in order to broadcast an IRDTV channel;

4. The objects of claim 2 wherein the external, battery-powered receiver unit receives said IRDTV wireless information, decodes said channel using the inverse process of claim 3 into RFATSC, then carries RFATSC into the TV's RFATSC input via a flexible metal rod with an F, Male connector.

5. The objects of claim 1 embodied as an external transmitter spaced between a Television with integrated IRATSC receiver consisting off:

6. The objects of claim 5 wherein the external transmitter unit accepts any analog or digital input, encodes said inputs into high definition through an MPEG 2 encoder,
re-encodes said signal into ATSC, splits ATSC into multiple channels through an 8 VSB modulator, adds a 4 Mhz signal which oscillates said channel modulation,
multiplies the three signal variables, adds two signal variables, amplifies the remaining signal, and sends said signal code to a hi frequency IR LED which pulsates according to said code in order to broadcast an IRATSC channel

7. The objects of claim 1 as an integrated transmitter unit for use within an Audio Video Device

8. The objects of claim 2 consisting of a fiber optic light emitting diode transmitter for the purpose of DTV transmission

9. The objects of claim 2 consisting of a fiber optic light receiving diode for the purpose of DTV acceptance

10. The objects of claim 2 as a portable, battery powered IR to RF converter mounted on a Television antenna reception Radio Frequency plug

11. The objects of claim 2 as a portable, battery powered RF to IR converter mounted on the source of RF signal transmission such as a set top box, game machine, personal computer, or any analog or digital AV signal

12. The objects of claim 1 wherein quadrature modulation and subsequent demodulation of IR for purposes of secure indoor video and audio transmission may be modified for worldwide DTV standards such as SECAM or NTSC or ATSC

13. The objects of claim 1 wherein RF heterodyne modulation and subsequent demodulation of IR for purpose of secure indoor video and audio transmission

14. The objects of claim 1 wherein wired IR repeating devices enable other rooms to publish secure audio and video transmission

15. The objects of claim 1 modified for laptops or other personal computers as portable transmitters and receivers

16. An h.264 infrared channel for the purpose of secure, wireless transmission of high-definition television content up to 1080p comprising:

17. The objects of claim 16 wherein an MPEG2 encoder is replaced with an h.264 endcoder for 1080p

18. A VC1 infrared channel for the purpose of secure, wireless transmission of high-definition television content up to 1080p comprising:

19. The objects of claim 18 wherein an MPEG2 encoder is replaced with a VC1 encoder for 1080p
